(19) United States
(12) Patent Application Publication
(10) Pub. No.: US 2021/0355676 A1
(43) Pub. Date: Nov. 18, 2021

(54) Clamp for Extending Height of Cubicle Walls

(71) Applicants: Mark Canavarro, Carlsbad, CA (US); Nicholas Canavarro, Carlsbad, CA (US)

(72) Inventors: Mark Canavarro, Carlsbad, CA (US); Nicholas Canavarro, Carlsbad, CA (US)

(21) Appl. No.: 16/891,278

(22) Filed: Jun. 3, 2020

Related U.S. Application Data
(63) Continuation of application No. 29/735,114, filed on May 18, 2020, now Pat. No. D909193.
(60) Provisional application No. 63/026,721, filed on May 18, 2020.

(51) Int. Cl. E04B 2/74; F16M 13/02

(52) U.S. Cl. CPC E04B 2/7416; E04B 2002/7418; F16M 13/02

(57) ABSTRACT

A system for extending the height of a cubicle wall is disclosed. The system comprises a vertical wall extender and a clamp. The clamp further includes an upper portion that receives the vertical wall extender, the upper portion further includes two jaws that apply a compressive force to the wall extender fixing it to the upper channel. The clamp also includes a lower portion that is mounted to the existing cubicle wall, the lower channel further includes two sections, the first section containing a nut channel with a nut disposed therein, the second section containing a slot through which the screw can thread into the nut. Further improvements for the system are disclosed, along with a method for using the system.

### CROSS-REFERENCE TO RELATED APPLICATIONS

This application claims priority as the non-provisional of U.S. Patent Application 63/026721 titled “CLAMP FOR EXTENDING HEIGHT OF CUBICLE WALLS” filed on May 18, 2020. This application also claims priority as a continuation of U.S. patent application Ser. No. 29/735114 titled “CLAMP FOR EXTENDING HEIGHT OF CUBICLE WALLS” filed on May 18, 2020. The entire contents of each of these applications are incorporated herein by reference in their entireties.

### FIELD OF THE INVENTION

This invention relates to clamps, and more particularly to the clamps for extending the height of cubicle walls.

### BACKGROUND

Cubicles, also known as cubicle desks, office cubicles or cubicle workstations, offer a less expensive alternative to office design and layout. A cubicle is a partially enclosed workspace, separated from neighboring workspaces by partitions that are typically 30 and 85 inches tall. Its purpose is to isolate office workers from the sights and noises of an open workspace, the theory being that this allows workers more privacy, and personalization, and helps them to concentrate without distractions. Horizontal work surfaces are usually suspended from the vertical walls of cubicles, as is shelving, overhead storage, and other amenities. Within the cubicle walls often run conduits that carry electrical and communications lines (i.e., telephone and internet), allowing each cubicle easy connection, as would be the case in a traditional office space.

Often, the building housing the cubicles is a single large room, and the cubicle can be used to compartmentalize that large room into individual work areas. And as the needs of the company change, say, for example, more people are hired, then the existing cubicles can be reconfigured to accommodate the change. This is a marked difference from traditional office space design that would require the erection of permanent walls to create individual offices. Traditional office design would not allow the work space to accommodate the changes in the company needs, instead requiring very expensive demolition and relocation of permanent walls, including all of the electrical and communication lines encased within those walls.

Existing cubicles come in a variety of vertical heights typically from 30 to 85 inches tall. Once the cubicle walls are installed, then several attachments can be made to those walls including shelves, bookcases, filing cabinet and desks. Also once installed an electrician will route the required electrical and communication lines through the cubicle wall conduits. Therefore, while cubicles are a flexible alterative, accommodating changes in layout and design, there can be significant expense in disassembling and reconstructing the cubicles when certain accommodations are desired.

One such accommodation is extending the height of the existing cubicle wall. For example, a work space may be initially provisioned as a collaborative space requiring constant face time between peers such that lower 30″ walls would be appropriate. However, that space may then be converted to a call center/customer service center requiring less collaboration and more separation (for example to lessen the amount of ambient noise to the customer when calling in).

Available cubicle design techniques and structure would require that shorter walls be replaced with taller walls. This, in turn, would require that the entire cubicle be disassembled (walls and attached horizontal surfaces), the internal wiring removed, new taller walls installed, new internal wiring run and the horizontal surfaces reinstalled. Not only is this expensive in installation labor and materials (i.e., new cubicle walls), it is also highly disruptive, requiring the cubicles be offline for several hours, if not days.

U.S. Pat. No. 8,561,355, granted to Canavarro, the same inventor of the present invention, provides a system for extending cubicle wall height wherein the lower portion of its clamp grips the existing cubicle wall, and an upper portion receives a vertical wall extender, and secures the wall extending material to the upper portion of the cubicle wall clamp with a screw. Although this provides easy and quick extension of the vertical cubicle wall, the prior art design limits the materials that could be used for the wall extender. For example, glass, certain plastics, or other brittle material could not be used, as the screw retention from the prior art design would dig into the prattle material at a single point and may cause a crack to propagate from that point, compromising the structure and safety of the wall extender, should that type of material be used. Furthermore, the previous design only works for a extension wall thickness that corresponds to the thickness of the upper channel of the clamp, so should the wall extender ever be replaced, it must be replaced by material of the same thickness.

What is therefore needed is a system for quickly and inexpensively extending the height of vertical walls on a cubicle, which gives more flexibility to the type of material that may be used to construct the cubicle extension wall, and which gives more flexibility to easy replacement of the cubicle wall extender, even with a different thickness of wall extender.

### SUMMARY

The present invention provides an elegant solution to the needs described above and offers numerous additional benefits and advantages, as will be apparent to persons of skill in the art. A clamp is disclosed for extending a cubicle wall. The clamp has an upper portion, a lower portion, and a screw connecting both portions. The upper portion has a first and second jaw. The first jaw includes a first jaw engagement surface, a first jaw mating slide rail, and a bottom surface with a mounting hole. The second jaw has a second jaw engagement surface and a second jaw mating slide rail that slides along the first jaw mating slide rail. Both slide rails are constructed to allow linear movement of the first jaw relative to the second jaw in a direction, and restrict non-linear movement thereof. A threaded shaft is threaded into a hole, wherein one of the jaws comprises the threaded shaft and the other comprises the threaded hole. Threading the shaft into the hole moves the first jaw relative to the second jaw along the direction allowed by the first and second jaw mating rail, thereby imparting a compressive force onto the vertical wall extender. A screw is disposed of in the mounting hole. A lower portion includes a first and second section, the first section containing a nut slot with a nut disposed therein. The second section has an elongate slot through which the screw can thread into the nut. Both the nut channel and elongate slot have a longitudinal axis that is perpendicular to the sides of the existing cubicle wall when the clamp is installed. The two sections are adapted to be fixed into contact with the sides of the existing cubicle wall when the screw is tightened to the nut. The nut slot is further constructed to restrict the nut from spinning during installation and allow the upper channel to be fixed into place at a position along the longitudinal axis of the elongate slot.

The compressive may be distributed across the first jaw engagement surface and the second jaw engagement surface. At least one of the first jaw engagement surface and the second jaw engagement surface may include a non-slip structure. This may be a compressive structure, which is more effective in mounting brittle materials, or materials of a non-uniform thickness.

The screw and/or the thread shaft may be an allen screw.

At least one of the two sections is textured so as to better grip the existing cubicle wall, and the sections may also have a protrusion that can also be textured. The nut channel may be plugged, narrowed or crimped to prevent the nut from exiting the nut channel.

A kit is also disclosed, as well as a method for using the clamp.

Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF THE DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views and/or embodiments. Furthermore, various features of different disclosed embodiments can be combined to form additional embodiments, which are part of this disclosure. It will be understood that certain components and details may not appear in the figures to assist in more clearly describing the invention.

FIG. 1 is an exploded view of the clamp with upper jaws and lower channel.

FIG. 2 illustrates the construction of the upper jaw and the slidable connection between the two upper jaws.

FIG. 3 illustrates the clamp fully assembled.

FIG. 4A illustrates the relative movement of the nut within the nut slot.

FIG. 4B illustrates all the pieces of the clamp, disassembled.

FIG. 5 illustrates the clamp connected to a cubicle wall and a cubical wall extender comprised of glass.

FIG. 6 is a bottom rear perspective view of the clamp.

FIG. 7 is a front view of the clamp.

FIG. 8 is a rear view of the clamp.

FIG. 9 is a left-side view of the clamp.

FIG. 10 is a right-side view of the clamp.

FIG. 11 is a top view of the clamp.

FIG. 12 is a bottom view of the clamp.

### DETAILED DESCRIPTION

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention. Various techniques and mechanisms of the present invention will sometimes be described in singular form for clarity. However, it should be noted that some embodiments include multiple iterations of a technique or multiple mechanisms unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

The following list of example features corresponds with the attached figures and is provided for ease of reference, where like reference numerals designate corresponding features throughout the specification and figures:

Clamp 10

Upper Portion 15

Upper Receiving Channel 12

First Jaw 20

Second Jaw 25

First Jaw Mating Slide Rail 30

Second Jaw Mating Slide Rail 35

First Jaw Bottom Surface 40

Tapered Mounting Hole 45

Upper Portion to Lower Portion Threaded Shaft/Screw 50

First Jaw Engagement Surface 52

Second Jaw Engagement Surface 54

Jaw Non-Slip Structure (may be semi-compressible) 55

First Jaw Threaded Hole 56

First Jaw to Second Jaw Threaded Shaft/Screw 57

Second Jaw Hole 58

Lower Portion 60

First Section 65

Second Section 70

Lower Receiving Channel 75

Nut 80

Non-Rotatable Nut Slot 85

Nut Slot Plug or Crimp 87

Elongate Slot 90

Elongate Slot/Non-Rotatable Nut Slot Longitudinal Axis 92

Protrusion 95

Relative Adjustment/Movement of First Jaw to Second Jaw 100

Relative Adjustment/Movement of Upper Portion to Lower Portion105

Relative Adjustment/Movement of First Section to Second Section 110

Movement of Nut in Non-Rotatable Nut Slot 115

Wrench for First Jaw to Second Jaw Fastener 120

Wrench for Upper Portion to Lower Portion Fastener 125

Cubicle Wall 130

Wall Extender 135

Adjustment/Movement of Wall Extender Position 140

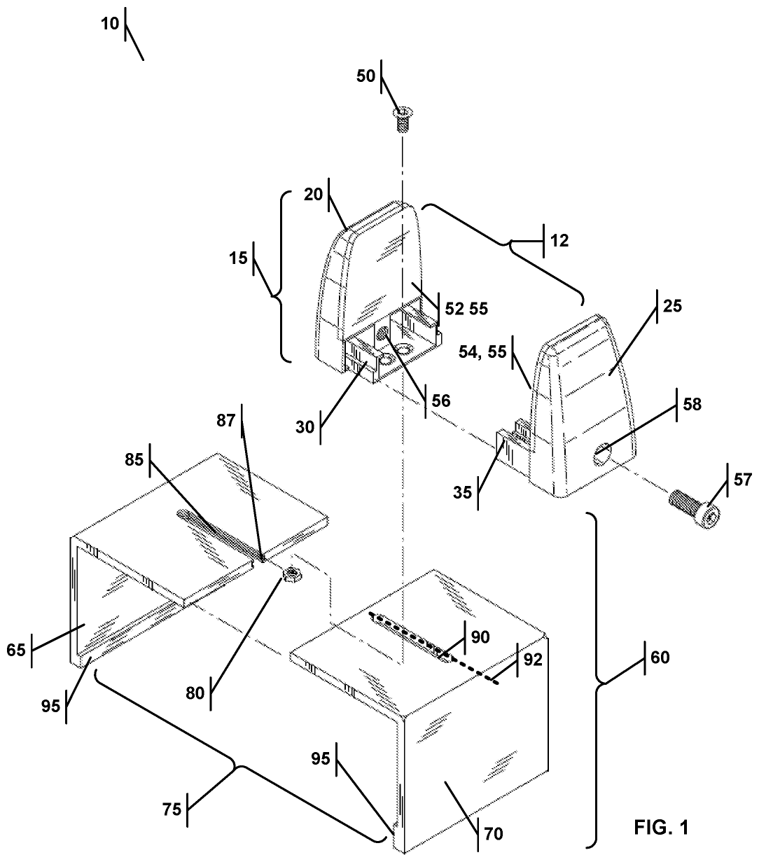

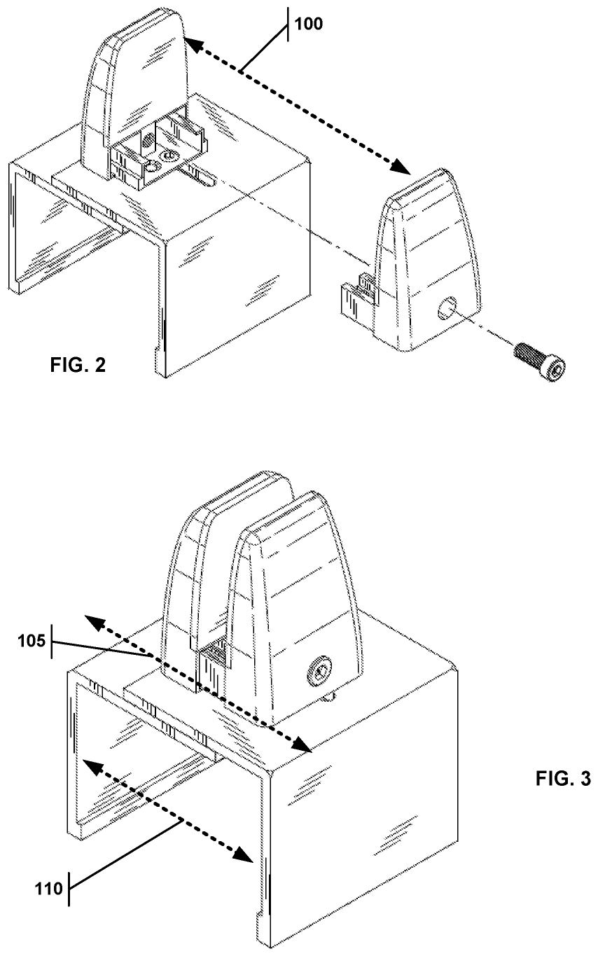

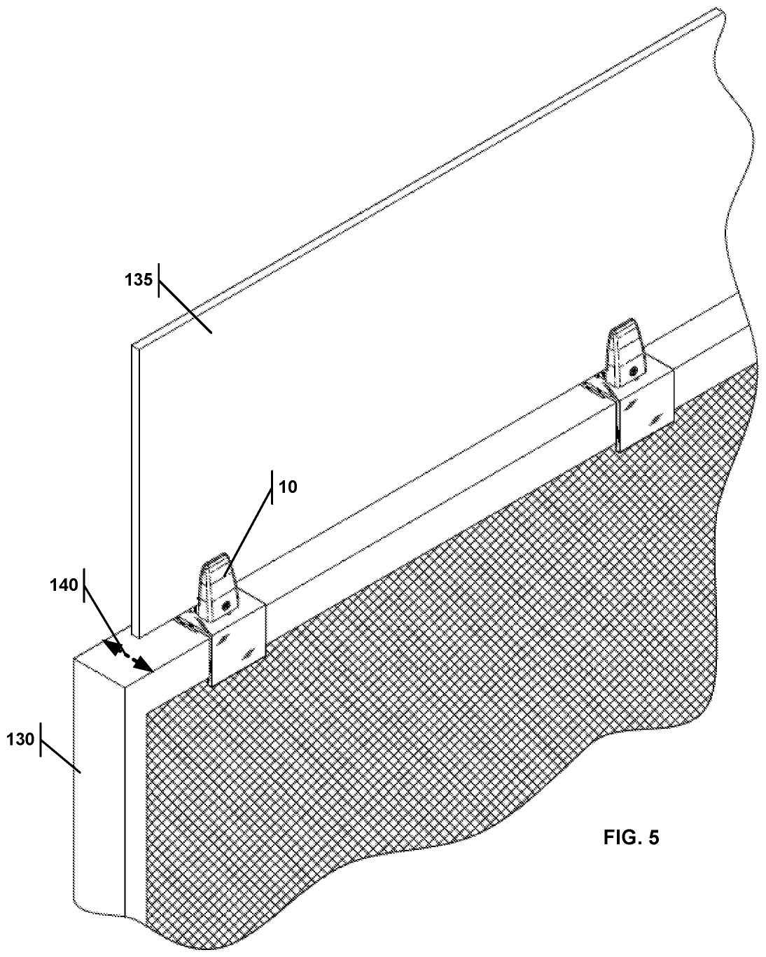

FIG. 1 illustrates the novel clamp (10) used in the system. The clamp (10) comprises an upper portion (15) and a lower portion (60). The upper portion (15) is adapted to receive a vertical wall extender (135), shown in FIG. 5. The upper portion (15) comprises a first jaw (20), a second jaw (25), and a threaded shaft (57) connecting the two jaws (20, 25). The first jaw (20) has a first jaw engagement surface (52), a first jaw mating slide rail (30), and a bottom surface (40) with a mounting hole (45). The second jaw (25) has a second jaw engagement surface (54), as well as a second jaw mating slide rail (35) constructed to slide along the first jaw mating slide rail (30). The two mating slide rails (30, 35) are constructed to allow a linear movement of the first jaw (20) relative to the second jaw (25), and substantially restrict non-linear movement of the first jaw (20) relative to the second jaw (25). This linear relative adjustment or movement of the two jaws is shown by arrow (100) in the perspective view of FIG. 2, and again in the alternative, rear view of FIG. 8. This relative adjustability (100) between the two jaws (20, 25), along with the jaw engagement surfaces (52, 54) that may apply a compressive or gripping force, would enable the upper receiving channel (12) formed between the two jaws (20, 25) to receive a wall extender (135) constructed of a brittle material, or a wall extender (135) of a varying or different thickness, which is not featured in the prior art. To further help grip the wall extender (135) the engagement surfaces (52, 54) may have a jaw non-slip structure (55) that may be made of a semi-compressible such as rubber or plastic.

In FIG. 1, there is also illustrated a lower portion (60) adapted to be mounted to an existing cubicle wall (130) with a top and side walls, which comprises a first section (65) and a second section (70). The first section (65) contains a nut slot (85) with a nut (80) disposed therein. The second section (70) contains an elongate slot (90), through which a screw (50) can thread into the nut (80) via the mounting hole (45) that is on the first jaw (20). The nut channel or slot (85) and the elongate slot (90) have a longitudinal axis (92) that is perpendicular to the sides of the existing cubicle wall (130) when the clamp (10) is installed. The two sections (65, 70) are adapted to be fixed into contact with the sides of the existing cubicle wall (130) when the screw (50) is tightened into the nut (80), securing the clamp (10) to the existing cubicle wall (130). The nut slot or channel (85) is constructed to restrict the nut from spinning during installation, and allows the upper channel (12) between the two jaws (20, 25) in the upper portion (15) to be fixed into place at a position along the longitudinal axis (92) of the elongate slot (90) in the lower portion (60).

At least one of the first and second sections (65, 70) may have a protrusion (95) to assist in better gripping the existing cubicle wall (130). This protrusion may be rigid, or may be a compressible material. Alternatively, at least one of the two sections (65, 70) may be textured, so as to better grip the existing cubicle wall (130). Furthermore, any protrusions (95) constructed on the first and second sections (65, 70) may be textured so as to better grip the existing cubicle wall (130). FIG. 1 also illustrates a nut slot plug or crimp (87), which may be a part of the nut channel (85), to prevent the nut (80) from exiting the nut channel (85). The nut channel (85) may, in lieu of or in addition to the plug (87), be narrowed at one end to prevent the nut (80) from exiting the nut channel (85).

The clamp (10) may further feature, as a way of securing the two jaws (20, 25) together in the upper portion (15), a first jaw threaded hole (56) in the first jaw (20), and a threaded shaft (57) threaded into the first jaw threaded hole (56). The threaded shaft (57) may also go through a second jaw hole (58) that may be threaded or not threaded. It is equivalent to have the threaded shaft (57) thread into the second jaw hole (58) from the other direction, as would be obvious to one of skill in the art. What is essential here is that one of the jaws comprises the threaded shaft, and the other comprises the threaded hole, and wherein threading the shaft into the hole moves the first jaw (20) relative to the second jaw (25) along the direction allowed by the first and second jaw mating rails (30, 35), thereby imparting a compressive force onto the vertical wall extender (135), holding it in place.

Note that the vertical wall extender (135) of the present invention is secured above the threaded shaft (57) and the mating rails (30, 35), seen in FIG. 5. At least one of the first jaw engagement surface (52) and the second jaw engagement surface (54) comprises a non-slip structure. The compressive force on the wall extender (135) is imparted by the threaded shaft (57) in the threaded hole (56), but the force is distributed across the first jaw engagement surface (52) and the second jaw engagement surface (54), such that the force is not applied to the wall extender (135) at a single point, and the clamp (10) is less likely to cause a crack to form and propagate in a wall extender (135) made of brittle material. The threaded shaft (57) may be a screw, and may furthermore be an allen screw. Also having the compressive force distributed across the first jaw engagement surface (52) provides a more secure grip on the wall extender (135). To further help grip the wall extender (135) the engagement surfaces (52, 54) may have a jaw non-slip structure (55) that may be made of a semi-compressible such as rubber or plastic.

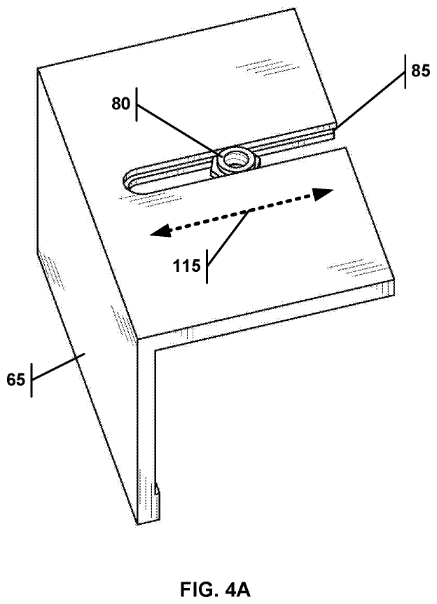

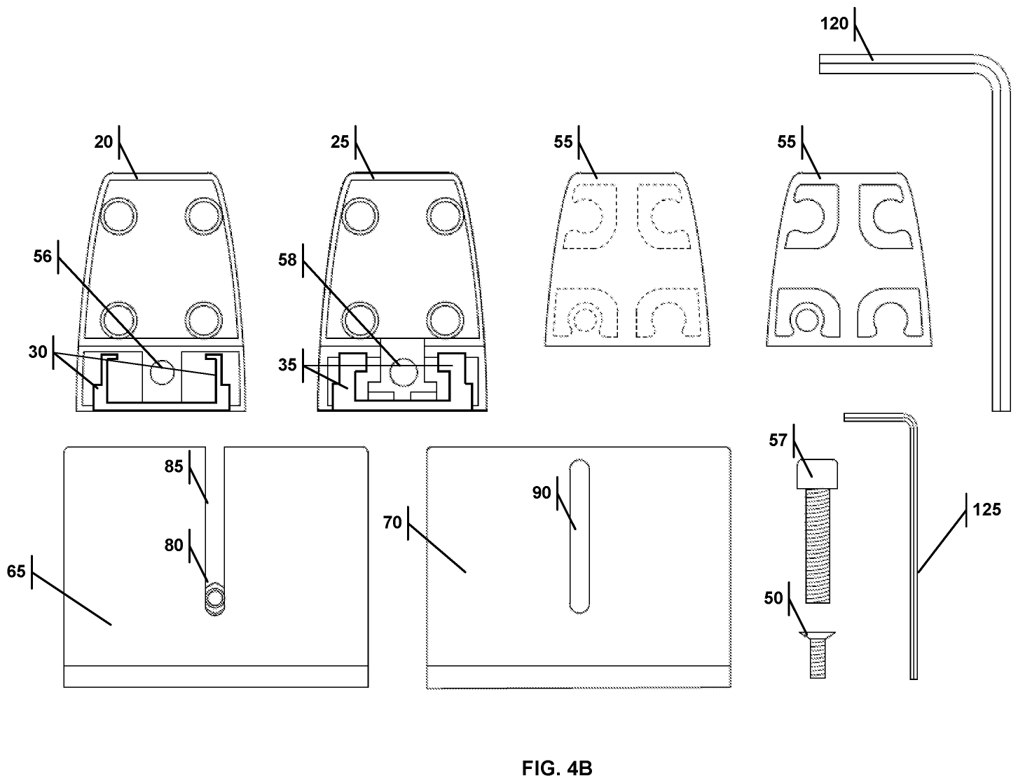

FIG. 2 illustrates the relative movement and adjustability of the two jaws, adjusted via the threaded shaft and threaded hole as well as adjusting the mating rails. FIG. 3 shows that there can also be relative adjustment or movement of the upper portion relative to the lower portion (105), and relative adjustment or movement of the first and second sections in the lower portion, all of which can be adjusted by sliding the sections/portions along the non-rotatable nut slot longitudinal axis (92) before tightening the screw (50) into the nut (80). FIG. 4A shows that the nut (80) may slide freely in the longitudinal direction (115) along the non-rotatable nut slot (85).

Another aspect of the present invention is a kit for extending the height of a cubicle wall, comprising a vertical wall extender (135) and the clamp (10) described in the preceding paragraphs. FIG. 4B presents a kit for extending the height of a cubicle wall, with the parts of the system dissembled. The system of the kit includes screws (50, 57), allen wrenches (120, 125), the first jaw (20), the second jaw (25), and one or more jaw engagement surfaces (52, 54), which may be built-in to the first and second jaws (20, 25) or may be constructed to snap into place on the jaws, the nut (80), and the first and second sections (65, 70) of the lower portion that secures to the existing cubicle wall (130). As discussed previously, the screw (50) mates with the nut (80) through the mounting hole (45, not pictured here but shown in the perspective view of FIG. 1), the elongate slot (90), and the nut slot or channel (85) to assemble the first jaw (20), first section (65), and second section (70) atop the existing cubicle wall (130). A wrench (125) may be provided to screw the screw (50). A threaded shaft or second screw (57) is used to secure the second jaw (25) to the assembly, and may use the wrench (120).

FIG. 5 illustrates the fully assembled clamp (10) installed onto an existing cubicle wall (130), with the wall extender (135) fitting into the clamp. The arrows (140) indicate that as the first and second lower sections of the clamp (10) are adjustable relative to one another, the clamp (10) may be adjusted to fit various thicknesses of existing cubicle walls (130).

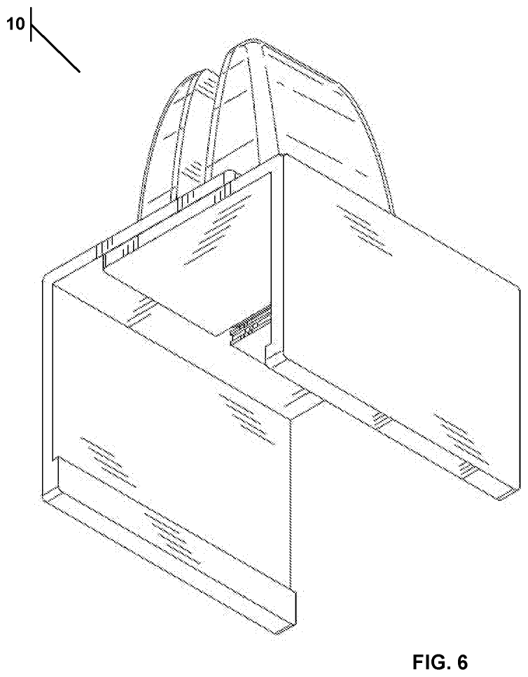

FIG. 6 shows a bottom perspective view unobstructed by the cubicle wall.

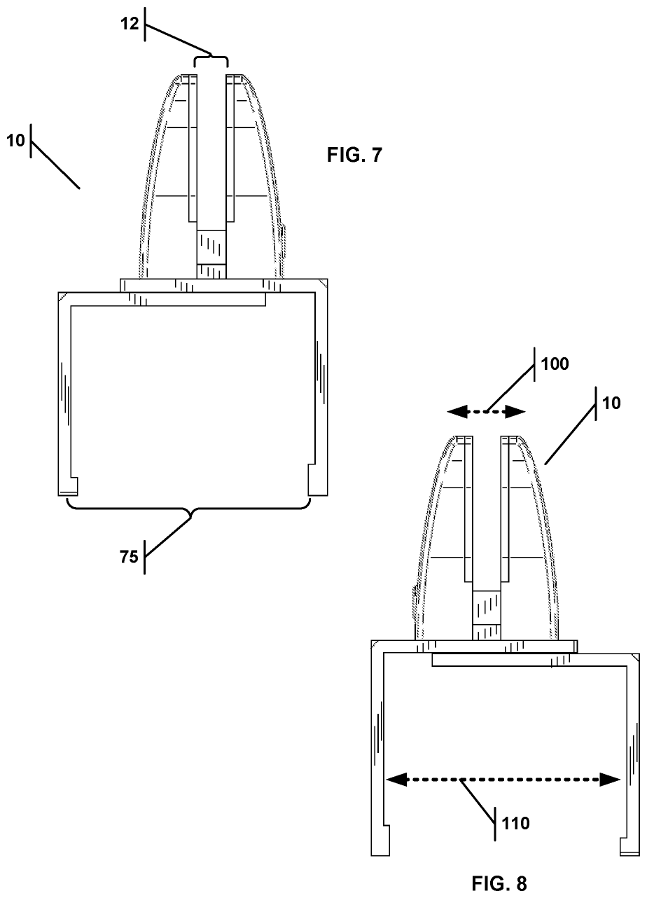

FIGS. 7-8 show front and rear views that illustrate the upper receiving channel (12) and lower receiving channel (75) of the assembled clamp (10), as well as the adjustability of the width (100) of the upper receiving channel (12), resulting from the relative movement of the two jaws, and the adjustability of the width (110) of the lower receiving channel (75), resulting from the relative movement between the first and second sections of the lower portion of the clamp (10) along the longitudinal direction.

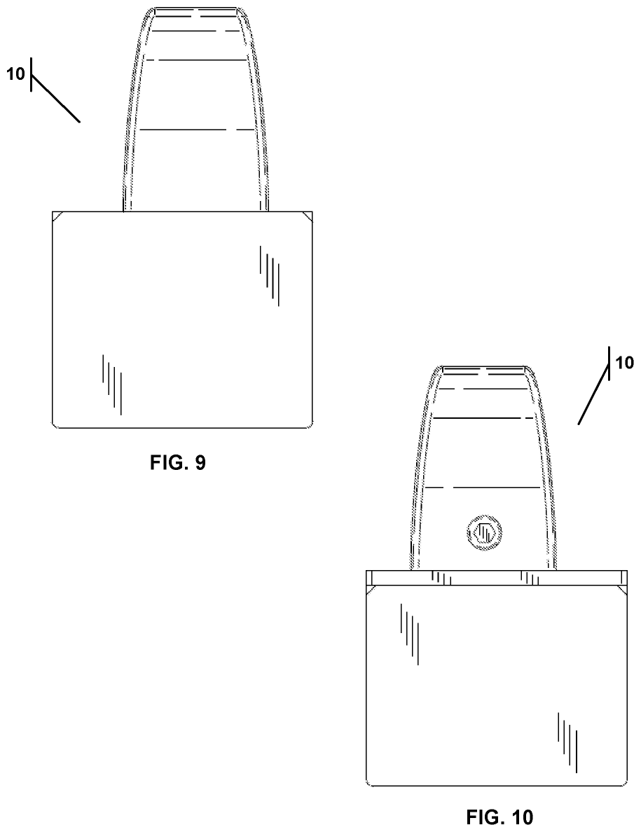

FIGS. 9-10 offer side views. The threaded shaft is visible in FIG. 10 but not FIG. 9, as the embodiment shown features only one threaded hole, not two. Whether an embodiment features a threaded hole in each jaw or a threaded hole in only one of the two jaws, is an obvious variation that does not depart from the scope and spirit of this invention to one of skill in the art.

FIG. 11 depicts the assembled clamp (10) in a top view and depicts the relative adjustment or movement (105) of the upper portion to the lower portion.

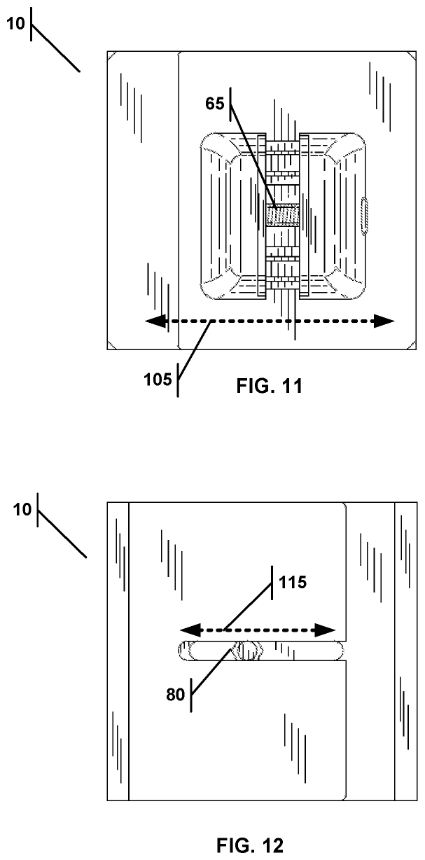

FIG. 12 depicts the assembled clamp (10) in a bottom view and depicts the movement (115) of the nut (80) in its non-rotatable slot.

By having the adjustable width on the upper portion (15) and the lower portion (60) shown by arrows 100 and 110, respectively, the clamp (10) is universal in that it can accommodate cubicle walls (130) and wall extenders (135) of various widths. The following is a non-exhaustive chart providing three different sized clamps with the dimensions each clamp will accommodate. It will be apparent that other clamp sizes may be constructed without deviating from the invention as disclosed and claimed herein.

CHART 1
CLAMP SIZES AND ACCOMMODATION DIMENSIONS

| | Minimum Cubicle | Maximum Cubicle |
|---|---|---|
| Clamp | Wall Width | Wall Width |
| Size | Accommodated (inches) | Accommodated (inches)) |
| Small | 1.0 | 1.5 |
| Standard | 1.5 | 2.5 |
| Large | 2.5 | 3.75 |

Another aspect of the present invention is a method for extending the height of a cubicle wall in association with the system of the present invention. The method for extending the cubicle wall height comprises the following steps: providing a vertical wall extender (135); providing a clamp (10) as described in the preceding paragraphs; adjusting the first and second sections (65, 70) so as to receive the cubical wall (130); sliding the first and second sections (65, 70) towards each other; adjusting the position of the upper portion (15); tightening the screw (50); inserting the vertical wall extender (135) into the upper portion (15); and actuating the threaded shaft (57) to impart the compressive force on the vertical wall extender (135) provided.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus it is to be understood that the description and drawings presented herein represent a presently-preferred embodiment of the invention and are therefore representative of the subject matter which is broadly contemplated by the present invention. It is further understood that the scope of the present invention fully encompasses other embodiments that may become obvious to those skilled in the art, and that the scope of the present invention is accordingly limited by nothing other than the appended claims.

1. A clamp comprising:
an upper portion adapted to receive a vertical wall extender, the upper portion comprising:
a first jaw with a first jaw engagement surface, a first jaw mating slide rail, and a bottom surface with a mounting hole;
a second jaw with a second jaw engagement surface and a second jaw mating slide rail constructed to slide along the first jaw mating slide rail, wherein both mating slide rails are constructed to allow linear movement of the first jaw relative to the second jaw in a direction, and substantially restrict non-linear movement of the first jaw relative to the second jaw;
wherein the first jaw engagement surface is about the same size as the second jaw engagement surface;
a threaded shaft threaded into a threaded hole, wherein one of the jaws comprises the threaded shaft and the other comprises the threaded hole, and wherein the threading the shaft into the hole moves the first jaw relative to the second jaw along the direction allowed by the first and second jaw mating rail, thereby imparting a compressive force onto the vertical wall extender;
a screw disposed of in the mounting hole;
a lower portion adapted to be mounted to an existing cubicle wall, the existing cubicle wall having a top and sides, the lower portion comprising:
a first and second section, the first section containing a nut slot with a nut disposed therein, the second section containing an elongate slot through which the screw can thread into the nut, both the nut slot and elongate slot having a longitudinal axis that is perpendicular to the sides of the existing cubicle wall when the clamp is installed, and
wherein the two sections are adapted to be fixed into contact with the sides of the existing cubicle wall when the screw is tightened to the nut;
wherein the nut slot is constructed to restrict the nut from spinning during installation and to allow the upper channel to be fixed into place at a position along the longitudinal axis of the elongate slot.

2. The clamp of claim 1, wherein the compressive force is distributed across the first jaw engagement surface and the second jaw engagement surface.

3. The clamp of claim 2 wherein the screw and/or the thread shaft is an allen screw.

4. The clamp of claim 1 wherein at least one of the two sections is textured so as to better grip the existing cubicle wall.

5. The clamp of claim 1 wherein at least one of the two sections has a protrusion.

6. The clamp of claim 5 wherein the protrusion is textured so as to better grip the existing cubicle wall.

7. The clamp of claim 1 wherein the nut slot comprises a plug to prevent the nut from exiting the nut slot.

8. The clamp of claim 1 wherein the nut slot is narrowed at one end to prevent the nut from exiting the nut slot.

9. The clamp of claim 1, wherein at least one of the first jaw engagement surface and the second jaw engagement surface comprises a non-slip structure.

10. A kit for extending the height of a cubicle wall, the system comprising:
a vertical wall extender; and
a clamp according to claim 1.

11. The kit of claim 10, further comprising a wrench to screw at least one of the screw and threaded shaft.

12. A method for extending the height of a cubicle wall, the method comprising:
providing a vertical wall extender;
providing a clamp according to claim 1;
adjusting the first and second sections so as to receive the cubicle wall;
sliding the first and second sections towards each other;
adjusting the position of the upper portion;
tightening the screw;
inserting the vertical wall extender into the upper portion; and
actuating the threaded shaft to impart the compressive force on the vertical wall extender.
